(19) United States
(12) Patent Application Publication
(10) Pub. No.: US 2015/0101545 A1
(43) Pub. Date: Apr. 16, 2015

(54) Portable pet grooming aid device and pet carrier

(71) Applicant: JOYCE DORFMAN, DUNCANVILLE, TX (US)

(72) Inventor: JOYCE DORFMAN, DUNCANVILLE, TX (US)

(21) Appl. No.: 14/465,809

(22) Filed: Aug. 21, 2014

Related U.S. Application Data
(63) Continuation of application No. 13/399,492, filed on Feb. 17, 2012, now abandoned.

(51) Int. Cl. A01K 13/00; A01K 1/00

(52) U.S. Cl. CPC A01K 13/00; A01K 1/00
USPC 119/650

(57) ABSTRACT

Disclosed is a portable pet grooming aid device comprising a substantially rectangular piece of flexible fabric comprising four sides, two sides joined creating a tubular flexible body having a top face, an inner face, a head end and a tail end, the ends comprising a seam, an elastic cord threaded inside of the seam, two apertures on the top face, the apertures affording a user's hands access to the interior of the device to handle an animal inside of the device during a grooming process, the animal's head exposed outside of the device at the head end, the elastic cord securely tied around the animal's neck.

### CONTINUATION-IN-PART APPLICATION

This application is a Continuation-in-Part application that claims priority to and incorporated by reference in full U.S. patent application Ser. No. 13/399,492 entitled “Portable pet grooming aid device and pet carrier” filed on Feb. 17, 2012 by the same inventor.

### BACKGROUND OF THE INVENTION

The disclosed invention is directed to devices that facilitate the washing of an animal. Bathing a pet such as a dog can be a trying process. Containing the pet during the bathing is a challenge. Transporting the animal to and from the groomer can be challenging too. Maintaining a clean environment in the grooming area is also a challenge because the dog will tend to want to shake off the body wetness and along with it splatter grooming chemical products, moisture, and loose hair onto the grooming environment. The disclosed device addresses the above challenges associated with management of an animal during and after a grooming process.

Improved pet carriers are known. See for example U.S. Pat. No. 7,040,254 to Rucker at al. entitled “Transportable animal washing apparatus,” U.S. Pat. No. 7,934,473 to Jonathan Mirsky entitled “Pet carrier access portal” and Patent Application Publication 2006/0060155 to I p. The applicant however is not aware of an inexpensive, simply-constructed portable pet containment device that is also a pet groom aid device having the benefits and features as described herein, including the benefit of affording the animal freedom of movement inside of the device for purpose of shaking off fluid during a wet grooming procedure performed while the animal is inside of the device.

### SUMMARY OF THE INVENTION

Disclosed is a portable pet grooming device comprising a substantially rectangular piece of flexible fabric comprising four sides, two sides joined creating a tubular flexible body having a top face, an inner face, a head end and a tail end, the ends comprising a seam, an elastic cord threaded inside of the seam, two apertures on the top face, the apertures spaced apart to afford a user's hands access to the interior of the device to handle an animal inside of the device during a grooming process, the animal's head exposed outside of the device at the head end, the elastic cord securely tied around the animal's neck. The disclosed device may optionally be used as a disposable device or as multiple-use, washable device. An important feature of the disclosed invention is that the device affords the animal the space to stand inside of the device and shake off washing fluid during a wet grooming procedure performed while the animal is inside of the device.

Per one embodiment the device is constructed of a fabric that is a silky, smooth nylon that repels hair such as the fabric used for customer garments (gowns) at hair salons. Per an alternative embodiment, the fabric is a transparent (or opaque) plastic material such as that used in shower curtains. Per another embodiment of the disclosed device, the fabric composes an interior layer of absorbent material such as terrycloth. Per yet another embodiment, the fabric is an absorbent cotton or cotton blend fabric such as that typically used for patient examination gowns in medical offices. Alternatively, the fabric may be a material that has stretch and recovery properties, such as, by way of example and not by way of limitation, LYCRA®. The preferred embodiment of the disclosed device comprises an elastic cord in the tail end and the head end that the user manually ties to secure the pet inside of the device. The elastic cord may be a closed loop or alternatively it may be a length of elastic with two ends that loosely adapts to the animals neck and tail without pinching the animal.

The disclosed pet grooming aid device is readily cleaned after the animal is removed from the device. As an example and not by way of limitation, the disclosed device may be reversed inside out to expose and wash its inner face. Alternatively, the device may simply be shaken to loosen and discard hair and residue from the pet cleaning. The device embodiment constructed of hair-repelling nylon is especially suited for the latter type of cleaning.

The device is also suitable as a pet carrier to help minimize the occurrence of loose pet hair in the environment. Thus, the disclosed device may be used as a pet containment/pet carrier device in combination with a standard car seatbelt. The male portion of the seatbelt is threaded through one aperture (or both apertures) of the disclosed device, and then locked into the female or buckle portion of the car seatbelt. In such uses, the disclosed device promotes the animal's safety in the car while promoting a clean and dry environment inside of the car even when transporting a freshly-groomed animal. Per one embodiment of such pet carrier device, the device is constructed of fabric that has stretch and recovery properties.

The loop ends are preferably manually adjustable to securely and comfortably, loosely contain the pet inside of the device during grooming. The ends may be adapted with or without elastic tie or other suitable means designed to secure the head end and the tail end of the device with the pet securely inside of the device. An alternative closure means for the ends comprises buttons. It is dear that the ends of the device need to be loosely closed around the animals head and/or tail during a grooming procedure.

In the head of the animal is inserted inside the tail end of the device, then exposed on the head end of the device, the head end and tail end loosely tied. Preferably the tail of the animal is kept inside of the device with the tail end of the device securely tied. With the animal securely inside of the device, the groomer passes his/her hands through the apertures on the top face of the device to gain access to the animal and to control the animal during the washing. Water may be introduced into the device during washing by way of the apertures in the top face of the device. At the end of the washing procedure, water may be manually squeezed out of the device at the apertures and/or the ends of the device, or it may be vacuumed out of the device at the apertures. The animal preferably is manually dried at the end of the washing procedure while the animal is still in the device. The disclosed device is also suited for use in rooming procedures that valve dry powder shampooing, application of flee powder and/or other topical medications. To release the pet, the loops or ties at the head end of the device are loosened allowing the animal to exit the device or be removed from the device. The animal is allowed to exit the device preferably after the animal is manually dried while the animal is still inside of the device.

### BRIEF DESCRIPTION OF THE DRAWINGS

FIG. 1 is a perspective of a preferred embodiment of the disclosed pet grooming aid device.

FIG. 2 is perspective of a loop securement of the disclosed pet grooming aid device.

FIG. 3 is a top perspective of the preferred embodiment of the disclosed pet grooming aid device.

FIG. 4 is a perspective of an end of disclosed device.

FIG. 5 is a perspective of an end per an alternative version of the preferred embodiment of the disclosed pet grooming aid device.

FIG. 6 is a side perspective of the disclosed pet grooming aid device in use with a car seatbelt.

FIG. 7 is a front perspective of the disclosed pet grooming aid device in use with a car seatbelt.

FIG. 8 is a perspective of an after native embodiment of the disclosed pet grooming aid device

FIG. 9 is a perspective view of an alternative embodiment

FIG. 10 is top perspective of the open end of the alternative embodiment shown in FIG. 9

FIG. 11 is a top perspective of the disclosed device when flattened

FIG. 12 is a perspective of the bottom end of the alternative embodiment per FIG. 9

FIG. 13 is a top perspective of a cooling agent.

### DETAILED DESCRIPTION OF THE DRAWINGS

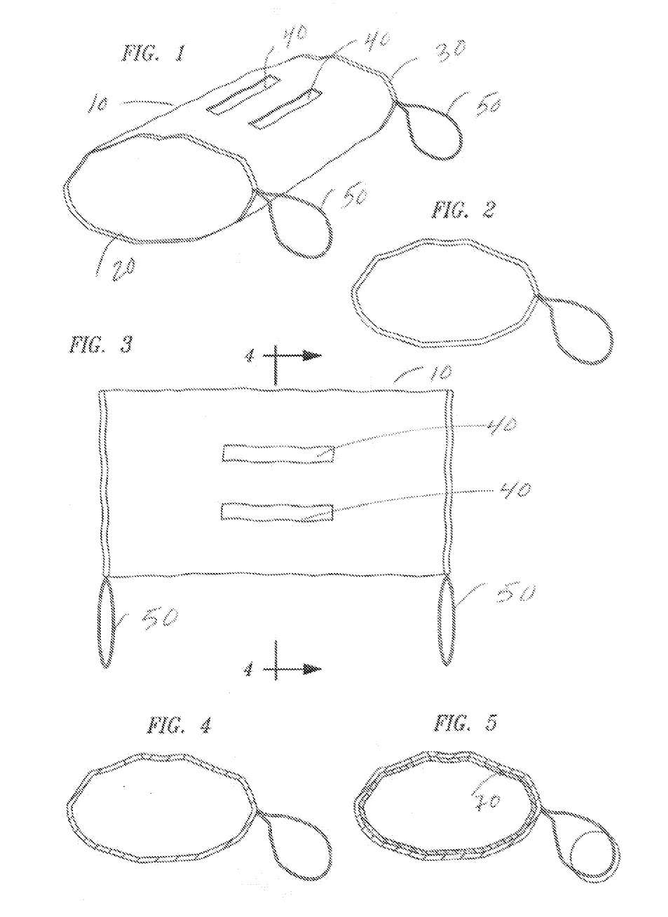

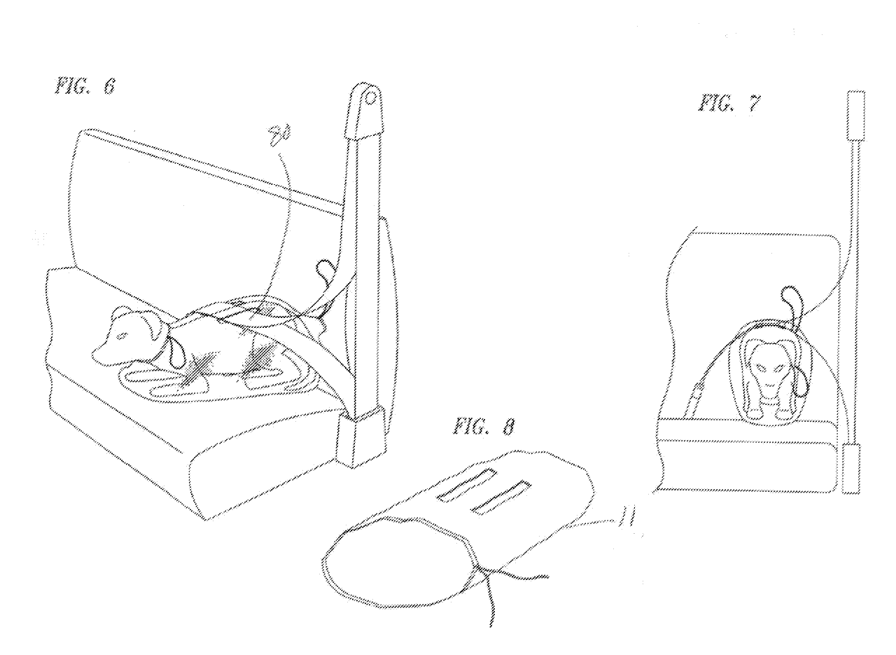

FIG. 1 is a perspective of a preferred embodiment of the disclosed pet grooming aid device 10 ready to receive a pet for grooming. Shown are two slits or apertures 40, tail end or opening 30, head end or opening 20, and elastic tie loops 50. FIG. 3 is a top view of the disclosed device when its flexible fabric is flattened. FIG. 5 is a perspective of an end per an alternative embodiment of the disclosed pet grooming aid device 10 comprising an inner surface comprising an absorbent layer 70 constructed of material such as terrycloth. FIGS. 6 and 70 show the disclosed pet grooming aid device used as a pet carrier and pet securement device inside of a car. The portion of the seatbelt 80 is threaded through one or both apertures 40 of the device and then locked with the female buckle portion of the seatbelt securing the pet to the car seat with the pet contained inside of the device. FIGS. 6 and 7 show the pet's tail optionally left outside of the device 10, wherein the tail end of the device is loosely tied with the pet's tail left outside of the device.

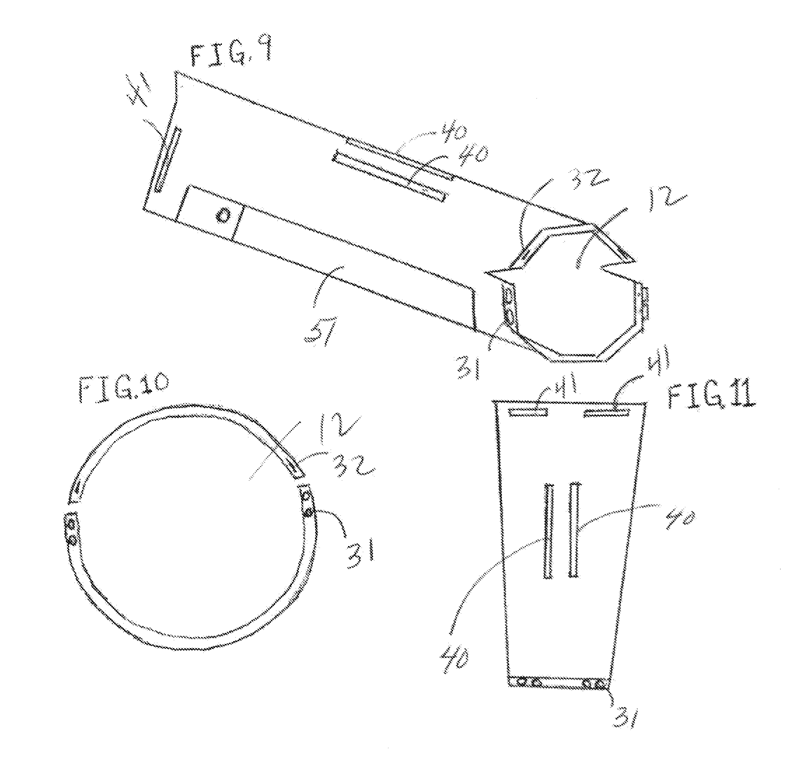

FIG. 8 shows an alternative embodiment that is pouch-like. Shown in FIG. 8 is a portable pet grooming aid device comprising a flexible fabric formed in a pouch having a body and an open end, the body of the pouch comprising a first aperture and a second aperture spaced part to allow a groomer's hands access to an animal inside of the pouch, the open end comprising a tiable cord. The cord may be made of thread or elastic or another suitable material.

FIG. 9 is a perspective view of an alternative embodiment of the disclosed pet carrier device showing an open end 12 having buttons 31 as closure means, two slits 40 for affording manual access to the animal during a grooming procedure and at least one slit 41 that is a third slit. The third slit 41 may be used to receive a securement device such as a seatbelt in a vehicle during transport of the animal inside of the device. Alternatively the third slit 41 may be used for securement of the device to a fixed station in a grooming area comprising a belt that is passed through the third slit 41 thus anchoring the device and the animal inside of the pouch during a washing of the animal and affording a groomer freedom to use both hands for accessing the animal inside of the device.

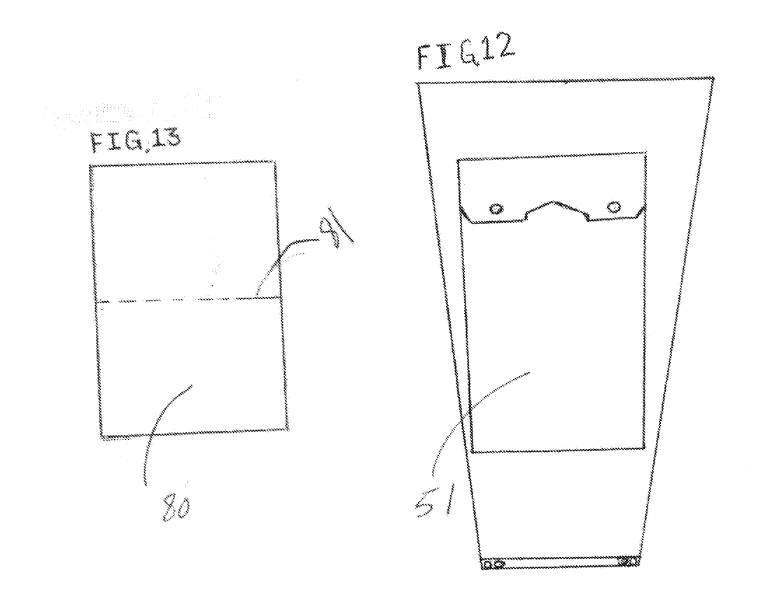

FIG. 10 is top perspective of the open end of the alternative embodiment shown in FIG. 9 and shows a preferred closure means comprising buttons 31 and at least one button hole 32.

FIG. 11 is a top perspective of the disclosed device per FIG. 9 when the fabric body is flattened.

FIG. 12 is a perspective of the bottom end of the alternative embodiment per FIG. 9 showing an outside closable pocket 51 for receiving cooling agent pouch 80 as shown in FIG. 13. The purpose of the cooling agent is to promote comfort of the animal during transport inside of the device. Per a preferred embodiment gel packs are used as the cooling agent and the gel packs may be folded at fold line 81 before being inserted in outside pocket 51 of the device.

I claim:

1. A portable pet grooming aid device comprising a substantially rectangular piece of flexible fabric comprising four sides, two sides joined creating a tubular flexible body having a top face, a bottom face, an outer face, an inner face, a head end, and a tail end, the ends comprising a closure means, a first aperture and a second aperture the top face spaced apart, the fabric sized to allow a pet to stand inside of the device and have freedom of movement inside of the device to be able to shake off washing fluid introduced into the device through the first or second aperture during a washing of the pet inside of the device.

2. The portable pet grooming aid device per claim 1 wherein the inner face comprises an absorbent fabric.

3. The portable pet grooming aid device per claim 1 wherein the flexible fabric comprises a transparent plastic material.

4. The portable pet grooming aid device per claim 1 wherein the flexible fabric comprises nylon.

5. A portable pet grooming aid device comprising a flexible fabric formed into a pouch having a body comprising an inner face and an outer face and an open end comprising a loose closure means, the body of the pouch comprising a first aperture, a second aperture spaced apart from the first aperture, a closable pocket on the outside face.

6. The device per claim 5 in combination with cooling gel placed inside of the closable pocket.

7. The device per claim 5 wherein the loose closure means comprises buttons.

8. The device per claim 5 further comprising a third aperture opposite the open end.

9. The device per claim 5 wherein the fabric is sized to allow a pet to stand inside of the device and have freedom of movement inside of the device to be able to shake off washing fluid introduced into the device through the first or second aperture during a washing of the pet inside of the device.
